(19) United States
(12) Patent Application Publication
(10) Pub. No.: US 2021/0348553 A1
(43) Pub. Date: Nov. 11, 2021

(54) METHOD AND SYSTEM FOR HYBRID OPPOSED PISTON INTERNAL COMBUSTION ENGINE WITH VOLUME SCHEDULING AND IGNITION TIMING CONTROLS

(71) Applicant: PINNACLE ENGINES, INC., San Carlos, CA (US)

(72) Inventors: Clayton NABER, San Mateo, CA (US); Keith JOHNSON, Oakland, CA (US)

(73) Assignee: PINNACLE ENGINES, INC., San Carlos, CA (US)

(21) Appl. No.: 17/222,887

(22) Filed: Apr. 5, 2021

Related U.S. Application Data
(60) Provisional application No. 63/006,042, filed on Apr. 6, 2020.

(51) Int. Cl. F02B 75/28; F02B 65/00; F02B 77/08; F02P 5/15

(52) U.S. Cl. CPC F02B 75/282; F02P 5/15; F02B 77/087; F02B 65/00

(57) ABSTRACT

A method and system for a hybrid opposed piston engine with dynamic controlling of the combustion volume and power output is provided. The method includes using a control system to control a phasing of opposed pistons for achieving a desired combustion volume during a combustion cycle. The control system can control an activation of an ignition of the hybrid opposed piston engine, such as to activate the ignition when a desired condition is present in the combustion chamber. Various embodiments of the hybrid opposed piston engine are further provided.

### CROSS-REFERENCE TO RELATED APPLICATION

This application claims priority to U.S. Provisional Application No. 63/006,042, entitled “HYBRID OPPOSED-PISTON INTERNAL COMBUSTION ENGINE WITH VOLUME SCHEDULING AND IGNITION TIMING CONTROLS” filed on Apr. 6, 2020, the content of which is expressly incorporated by reference herein in its entirety.

### TECHNICAL FIELD

The subject matter described herein relates to a method and system of a hybrid internal combustion engine, particularly a hybrid opposed piston internal combustion engine.

### BACKGROUND

An internal combustion engine can include a fixed cylinder and at least one moving piston. In such a configuration, expanding combustion gases in the cylinder can push the piston, which in turn rotates the crankshaft. Internal combustion engines can include multiple cylinders that turn a single crankshaft. Each cylinder can fire at a different time so, at any given moment, there can be at least one cylinder adding power and advancing the vehicle. The cylinders can be attached to the crankshaft by rods that connect to the pistons inside the cylinders.

In some opposed piston engines, two pistons come together within a cylinder and the piston crowns define the combustion chamber. The most common and widely deployed opposed piston engine can include two crankshafts with one crankshaft coupled to each of the opposed pistons. One of the design challenges associated with an opposed piston engine is the crank-to-crank mechanical linkage, such as due to friction, causing increased parasitic drag loss that can reduce thermodynamic efficiency and generate unwanted noise.

For example, an engine can lose up to 75% of its generated energy in the form of friction, heat transfer to the environment, and enthalpy lost to the exhaust gas stream. A major source of engine friction and wear can include forces exerted on the piston by the combustion gases and subsequently reacted through the connecting rod by the crankshaft. Furthermore, while high compression, lean-burn engines are generally more efficient, greater compression increases combustion gas pressure and temperature, increasing the likelihood of unwanted pre-ignition of fuel (commonly referred to as knock), and the higher combustion gas temperatures are responsible for the formation of NOₓ (oxides of nitrogen) emissions.

A traditional variable compression ratio engine can provide various advantages, such as preventing pre-ignition, such as by dropping the compression ratio during periods of high torque production to keep knock from happening, while increasing the ratio during periods of lower torque output, for greater efficiency (e.g., reduced exhaust loss due to a higher expansion ratio). This can provide additional power when needed, and better economy when not needed, but its efficacy is limited by NOx production that results when the compression ratio is increased. To avoid NOₓ production, the combustion event may be delayed as a countermeasure. However, doing so can reduce the realizable expansion ratio improvement of higher compression ratios. Typical approaches to variable-compression can use multiple-link piston rods where the piston rod has a central pivoting multi-link that can change angle, which in turn can change the effective length of the piston rod, thereby changing the amount the piston moves in the cylinder. The amount the piston moves in the cylinder can change the compression ratio.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 illustrates an example opposed piston engine consistent with implementations of the current subject matter;

FIG. 2 illustrates an embodiment of a hybrid opposed piston engine consistent with implementations of the current subject matter;

FIG. 3 illustrates a combustion cycle diagram consistent with implementations of the current subject matter;

FIGS. 4A, 4B, 4C and 4D illustrate various volume scheduling diagrams consistent with implementation of the current subject matter;

FIG. 5 shows a first process flow diagram illustrating aspects of a method having one or more features consistent with implementations of the current subject matter; and

FIG. 6 shows a second process flow diagram illustrating aspects of a method having one or more features consistent with implementations of the current subject matter.

When practical, similar reference numbers denote similar structures, features, or elements.

### DETAILED DESCRIPTION

Various embodiments of a hybrid opposed piston engine are described herein that include at least one electrical component configured to control at least one piston of the hybrid opposed piston engine. For example, the hybrid opposed piston engine can include a control system that controls a phasing of opposed pistons for achieving a desired combustion volume during a combustion cycle. In some embodiments, the control system can control an activation of an ignition of the hybrid opposed piston engine, such as to activate the ignition when a desired condition is present in the combustion chamber. Various embodiments of the hybrid opposed piston engine is described in greater detail below.

In some implementations, the hybrid opposed piston engine includes a first piston controlled by a first electrical component and a second piston controlled by a second electrical component. Additionally, the hybrid opposed piston engine can include at least one sensor associated with the first piston and second piston. For example, the sensors can be configured to sense one or more characteristics associated with the first and second pistons, including mechanical and/or electrical components associated with the first and second pistons.

In some embodiments, the hybrid opposed piston engine can include a control system configured to receive and analyze sensed data from the sensors for controlling the first and second pistons. For example, the control system can use the sensed data to control a phasing of the first and second pistons for achieving a desired combustion volume throughout a combustion cycle. In some embodiments, the control system can use the sensed data to determine a position and direction of movement of the first and second pistons for controlling an activation of an ignition of the hybrid opposed piston engine, such as to activate the ignition when a desired condition is present in the combustion chamber.

At least some benefits associated with the hybrid opposed piston engine of the present disclosure are disclosed herein. For example, controlling phasing of the first and second pistons to achieve a desired combustion volume can reduce load requirements of some of the electrical and/or mechanical components, as well as improve thermal efficiency. Additionally, controlling an activation timing of the ignition by the control system can ensure ignition activation occurs when an optimal or desired combustion volume is present in the combustion chamber. Other benefits and advantages of the present hybrid opposed piston engine are within the scope of this disclosure.

The electrical component of the hybrid opposed piston engine can include a motor and/or generator, such as an induction motor, a piezoelectric motor, and/or the like. The electrical component can eliminate frictional losses, thus increasing the net thermodynamic efficiency of the system. The hybrid opposed piston engine can comprise a battery cell (not shown) comprising of numerous interrelated electric cells for storing energy generated by the electric component as a generator.

Further, the hybrid opposed piston engine may achieve improved thermodynamic efficiency by dynamically manipulating the combustion volume in the cylinder through instantaneous electronic control of the position of one or both of the opposed pistons. By adding combustion volume as an additional degree of freedom with which to manage combustion temperature, NOₓ emissions can be reduced and thermodynamic efficiency can be improved.

For example, thermodynamic efficiency may be increased at low engine power output levels through continuously variable piston displacement. The travel of the opposed pistons can be controlled (e.g., via electrical components and control system), allowing the piston displacement of one or both of the opposed pistons to be adjusted to an optimal setting for a given engine power output level without changing the compression ratio. Implementations of the current subject matter may be applicable to single-cylinder or low cylinder count engines (e.g., two and/or three cylinders).

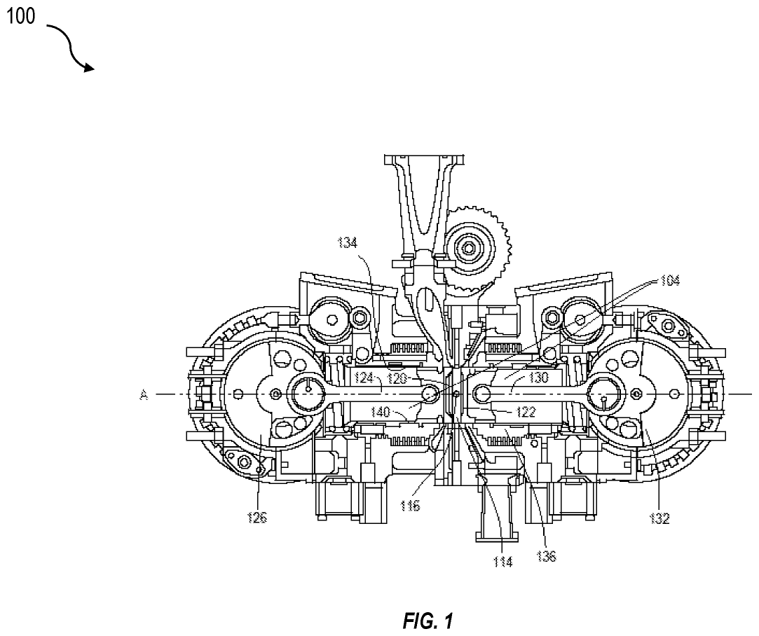

FIG. 1 illustrates an opposed piston engine 100 that includes two pistons that share a common cylinder and form a combustion volume defined by the pistons and the walls of the cylinder. Other engine configurations, such as for example those in which each piston is disposed in a separate cylinder whose combustion volume is formed by the piston, a cylinder head, and the walls of the cylinder, are also within the scope of the current subject matter.

As shown in FIG. 1, the opposed piston engine 100 is configured such that a first piston 120 and a second piston 122 reciprocate within a cylindrical chamber or cylinder 104 along a centerline A of the cylindrical chamber or cylinder 104. The first piston 120 is connected to a first connecting rod 124, which in turn connects to a first crankshaft 126. The second piston 122 is connected to a second connecting rod 130, which in turn connects to a second crankshaft 132. The first piston 120 reciprocates within the cylinder 104, and is slidably movable to the left and right (from the FIG. 1 perspective) along the cylinder wall 134. The right piston 122 also reciprocates within the cylinder 104, and is slidably movable to the left and right along the cylinder wall 134.

FIG. 1 also illustrates a sleeve valve body 140 that can be slidably movable to the left and right, such as relative to an oil-path defining piece 136. The first piston 120 and second piston 122 are disposed in the cylinder 104 as they would be at Top Dead Center (TDC), with the combustion volume, which is defined by the cylinder wall 134, the valve seat 114, and the piston heads of the first piston 120 and second piston 122, at its smallest. An engine can be configured such that the ignition timing occurs either at, before, or after the minimum combustion volume.

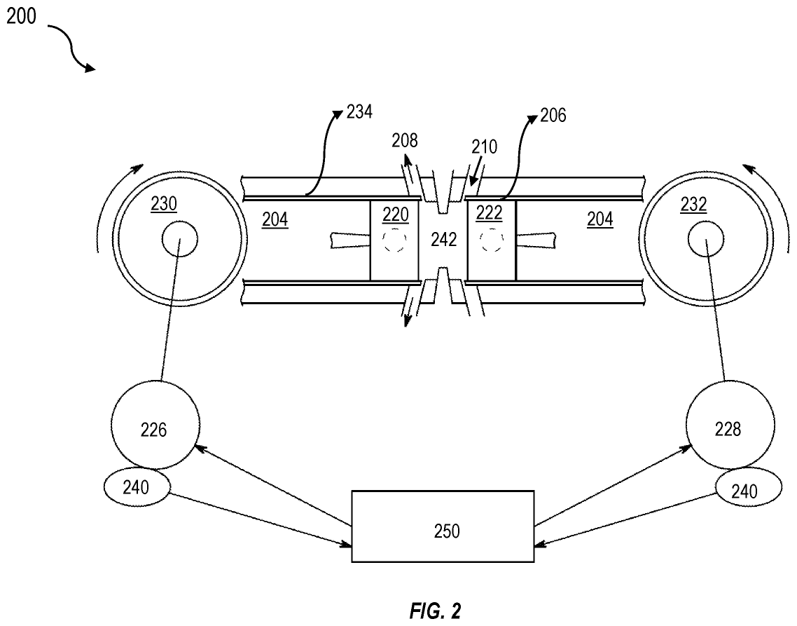

FIG. 2 illustrates another embodiment of a hybrid opposed piston engine 200. As shown in FIG. 2, a cylinder 204 can house a first piston 220 opposed to a second piston 222 centered along a linear axis of the cylinder 204 such that each piston crown is facing toward the other. A combustion chamber 242 may be formed within the cylinder 204 (e.g., defined by the cylinder wall 234 of the cylinder 204) and between the two piston crowns. One or more sleeve valves 206 coupled with the cylinder 204 may be disposed proximate to the combustion chamber 242. The first piston 220 and the second piston 222 may be configured for reciprocating motion along the inner wall 234 of the cylinder 204. An intake port 210 is configured to allow a mixture of air and fuel to flow into the cylinder 204 during the intake stroke. An exhaust port 208 is configured to allow exhaust gas to leave the cylinder 204 during the exhaust stroke.

As shown in FIG. 2, the first piston 220 of the hybrid opposed piston engine 200 can be coupled to a mechanical connecting rod and first crankshaft assembly 230 that includes a first electrical component 226. The mechanical connecting rod and first crankshaft assembly 230 along with the first electrical component 226 can cause the first piston 220 to reciprocate in the cylinder 204. For example, the first electrical component 226 can be configured to replace a mechanical connection between the crankshafts (e.g., a gear set or chain and sprockets that connect the second crankshaft).

The first electrical component 226 and second electric component 228 can comprise an electric motor and/or generator, such as an induction motor, a piezoelectric motor, and/or the like. When it functions as a motor, the electrical component can control first piston 220 or second piston 222 to optimize the power output and efficiency of fuel. When it functions as a generator, the electric component can recover the energy generated by deceleration/braking to recharge the battery. Thus, the electrical component can eliminate frictional losses, thus increasing the net thermodynamic efficiency of the system. The hybrid opposed piston engine can comprise a battery comprising of numerous interrelated electric cells for storing energy generated by the electric component as a generator and providing energy to control the pistons' position and movement by the electric component as an electric motor. According to some embodiments, the hybrid opposed piston engine can comprise a motor control module configured to control the operation of the electrical components 226 and 228. According to some embodiments, the hybrid opposed piston engine can comprise a battery control module to monitor the physical variables of the battery.

Additionally, as shown in FIG. 2, the second piston 222 of the hybrid opposed piston engine 200 can be coupled to a mechanical connecting rod and second crankshaft assembly 232 that includes a second electrical component 228. The mechanical connecting rod and second crankshaft assembly 232 along with the second electrical component 228 can cause the second piston 222 to reciprocate in the cylinder 204. For example, the second electrical component 228 can be configured to replace a traditional crankshaft and mechanical connection (e.g., to the crankshaft associated with the first piston).

For example, an instantaneous position of the first crankshaft assembly 230 and/or second crankshaft assembly 232 can be controlled via pulsewidth modulation of a current supplied to the first electrical component 226 and/or second electrical component 228, respectively. For example, the first and second electrical components 226, 228 may include a servo motor and at least one electrical control component.

As shown in FIG. 2, the hybrid opposed piston engine 200 can include a control system 250 configured to achieve volume scheduling. The control system 250 can comprise a power control module configured to modify the direction and output of the electric current between a battery and first electrical component 226 and second electrical component 228. The control system 250 can implement various volume scheduling control features via, for example, phasing control, ignition timing control, piston position control, etc. According to some embodiments, the volume scheduling can include phasing of the first piston 220 and/or the second piston 222 to achieve a desired combustion volume in the combustion chamber 242 during a combustion cycle. For example, the control system 250 of the hybrid opposed piston engine 200 can dynamically adjust the positions of both the first and second pistons 220, 222 within the cylindrical chamber during the combustion engine cycle to achieve the desired combustion volume during the combustion cycle.

According to some embodiments, the hybrid opposed piston engine 200 can be configured such that the position of each of the opposed pistons (the first piston 220 and the second piston 222) within the cylindrical chamber can be individually controlled. The ability to dynamically and individually control the position of both the first and second pistons 220, 222 can reduce the peak acceleration required by either the first or second crankshaft assemblies 230, 232 (e.g., allowing the first crankshaft assembly 230 to adjust some of the phase relationship rather than relying only on the second crankshaft assembly 232). Additionally, individually controlling the movement of first piston 220 and the second piston 222 can contribute towards improved thermodynamic efficiency.

In some embodiments, the control system 250 of the hybrid opposed piston engine 200 can communicate with the one or more sensors 240 and first and second electrical components 226, 228 to analyze and control one or more characteristics associated with the opposed piston engine, as will be described in greater detail below. For example, the hybrid opposed piston engine 200 can include a first sensor 240 associated with the first piston 220 and a second sensor 240 associated with the second piston 222. The first and second sensors 240 can, for example, include an angle encoder configured to sense angular position information of an associated crankshaft assembly. The sensors 240 can communicate the sensed data to the control system 250.

For example, based on the received sensed data from the sensors 240, the control system 250 can be configured to determine one or more of a position and an acceleration of the first and second pistons 220, 222. Furthermore, the control system 250 can also determine an expected combustion volume that is to be achieved during a combustion cycle based on the analyzed sensed data. The control system 250 can be configured to compare the determined expected combustion volume against a desired combustion volume and determine, based on such comparison, whether the phasing of the first and second pistons 220, 222 is needed to achieve the desired combustion volume. For example, if the control system 250 determines that phasing is needed to achieve the desired combustion volume, the control system 250 can further determine a change in position and/or change in acceleration of one or both of the first and second pistons 220, 222 for achieving such desired combustion volume. Based on the determined change in position and/or acceleration of the first and second pistons 220, 220, the control system 250 can control the first and second electrical components 226, 228 to achieve such changes.

For example, the control system 250 can receive sensed data from the sensors 240 (e.g., rotational speed of associated crankshaft assembly). The control system 250 can analyze the sensed data, including determining the expected combustion volume and compare such expected combustion volume against the desired combustion volume. The control system can further determine, based on such analyzing, the change in rotational speed of the crankshaft assemblies associated with the first and second pistons 220, 222 for achieving the desired combustion volume. For example, the sensor 240 can be configured to measure a position or state of a servo motor associated with a crankshaft. The control system 250 can control an amount of current to the servo motor for assisting with controlling movement of the crankshaft assembly (thereby controlling a position of the associated piston).

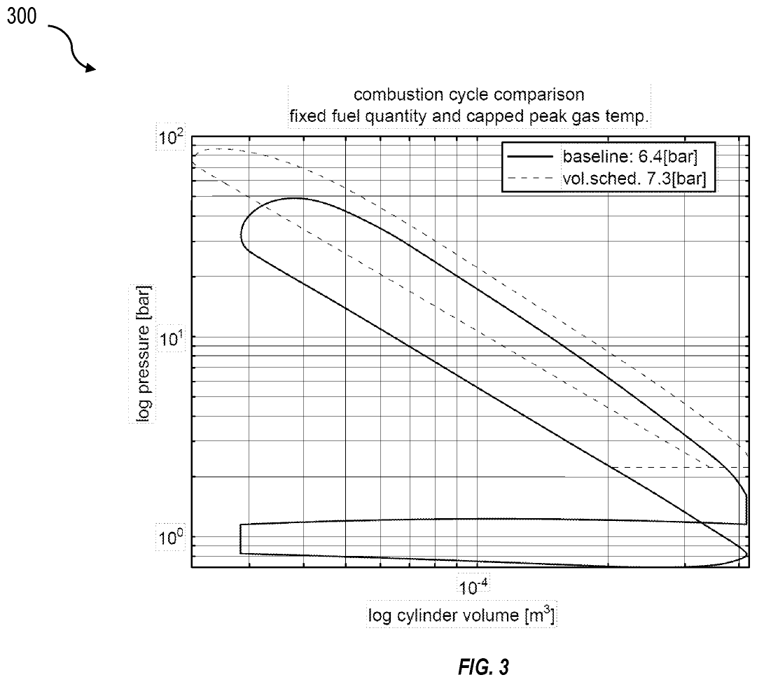

FIG. 3 illustrates a combustion cycle diagram consistent with implementations of the current subject matter. As shown in FIG. 3, when consuming the same quantity of fuel, a regular combustion cycle without volume scheduling, as indicated in solid lines, has a power output of about 6.4 bar. By contrast, a volume scheduling cycle of a hybrid opposed piston engine in dashed lines has an increased power output of 7.3 bar. In addition to increased output power, the hybrid opposed piston engine can produce increased fuel efficiency. As such, compared with a regular combustion cycle of an opposed piston engine, the volume schedule cycle of the hybrid opposed piston engine can achieve a higher power output with volume scheduling.

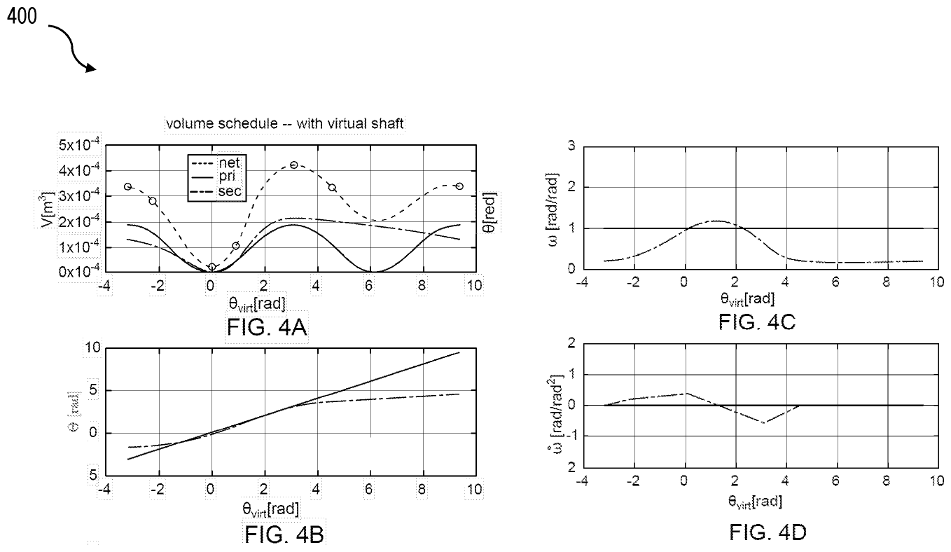

FIGS. 4A, 4B, 4C and 4D illustrate various volume scheduling diagrams consistent with implementations of the current subject matter. According to some embodiments, the combustion chamber of a hybrid opposed piston engine can be virtually divided into a primary combustion zone and a secondary combustion zone. The primary combustion zone can be associated with a primary crankshaft assembly, and the secondary combustion zone can be associated with a secondary crankshaft assembly.

As indicated in FIG. 4A of the virtual crankshaft angle and combustion volume diagram, the short-dashed line shows the combined net volume contribution of the primary combustion zone and the secondary combustion zone, the long-dashed line shows the net volume contribution of the primary combustion zone, and the solid line shows the net volume contribution of the secondary combustion zone. Further, FIG. 4B shows the independent crank positions of the primary crankshaft assembly and the secondary crankshaft assembly. FIG. 4C shows the independent crank speeds of the primary crankshaft assembly and the secondary crankshaft assembly. FIG. 4D shows the independent crank accelerations of the primary crankshaft assembly and the secondary crankshaft assembly. Accordingly, the movement position, speed, and accelerations of the primary crankshaft assembly and the secondary crankshaft assembly can be independently controlled by the corresponding electric motor to achieve the most optimized combined net volume.

Further, besides the increased combustion volume and power output, the hybrid opposed piston engine of the present subject matter can reduce the pre-ignition of fuel and decrease the formation of NOx emission. In the hybrid opposed piston engine, the two independently controlled primary crankshaft assemblies and their corresponding pistons can jointly form a combustion volume that is subject to a dynamic variable compression ratio control via the electric motors. Accordingly, the hybrid opposed piston engine can reduce the compression ratio during high torque production to prevent knock or pre-ignition of fuel. Similarly, the hybrid opposed piston can increase the compression ratio during lower torque production for improved fuel efficiency.

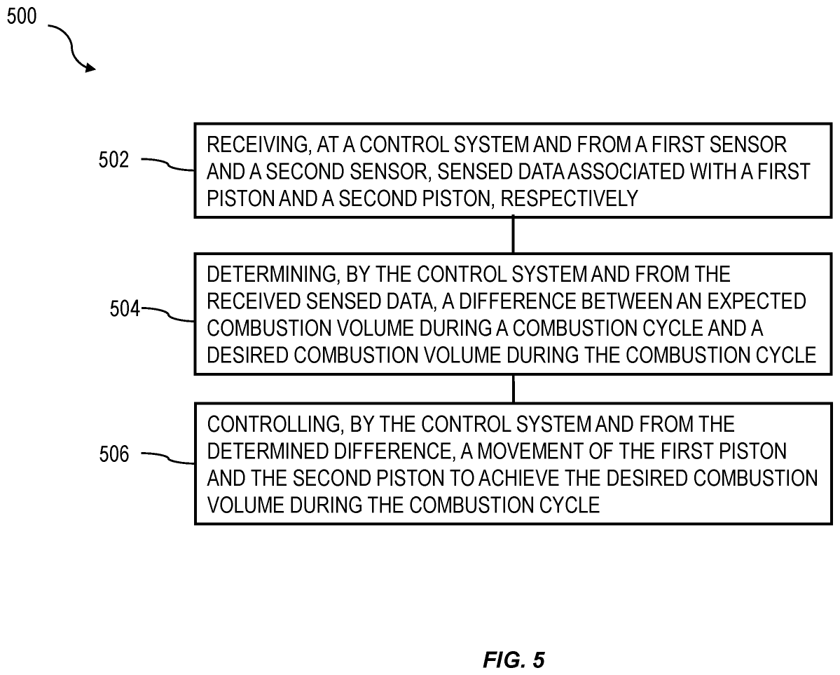

FIG. 5 shows a process flow chart 500 illustrating features of a method consistent with one or more implementations of the current subject matter including an ignition control feature. It will be understood that other implementations may include or exclude certain features. At 502, the control system 250 of the hybrid opposed piston engine 200 can receive sensed data from a first sensor 240 associated with the first piston 220 and/or first crankshaft assembly 230 and a second sensor 240 associated with the second piston 222 and/or second crankshaft assembly 232. At 504, the control system 250 can determine, from the received sensed data, a difference between an expected combustion volume during a combustion cycle and a desired combustion volume during the combustion cycle. At 506, the control system 250 can control, as a result of the determined difference, a movement of the first piston and the second piston to achieve the desired combustion volume during the combustion cycle. For example, the control system 250 can accelerate or slow a movement of the first piston 220 and/or the second piston 222 using the current provided by the first electrical component 226 and/or the second electrical component 228 to achieve the desired combustion volume.

In some embodiments, the control system 250 includes an ignition control feature for controlling the timing of ignition and combustion relative to the combustion cycle. For example, the ignition control feature can accurately schedule a spark from an ignition of the hybrid opposed piston engine 200 relative to a combustion volume in the combustion chamber 242, thus achieving a desired pressure and temperature during combustion. For example, the spark can be coordinated to coincide with a specific net internal combustion volume to ensure that combustion happens during an intended part of the combustion cycle. Accurate timing of combustion relative to the cylinder volume can affect pollutant formation and/or affect the energy efficiency of the combustion cycle.

The control system 250 can monitor the combustion volume in the combustion chamber 242 and direct the ignition to deliver a spark in the combustion chamber when the control system 250 determines a presence of the desired combustion volume in the combustion chamber. In addition, the control system 250 can monitor what direction the first and second pistons 220, 222 are traveling (e.g., towards or away from top-dead-center) to ensure a desired direction of travel of the first and second pistons 220, 222 before directing the ignition to deliver the spark to the combustion chamber 242.

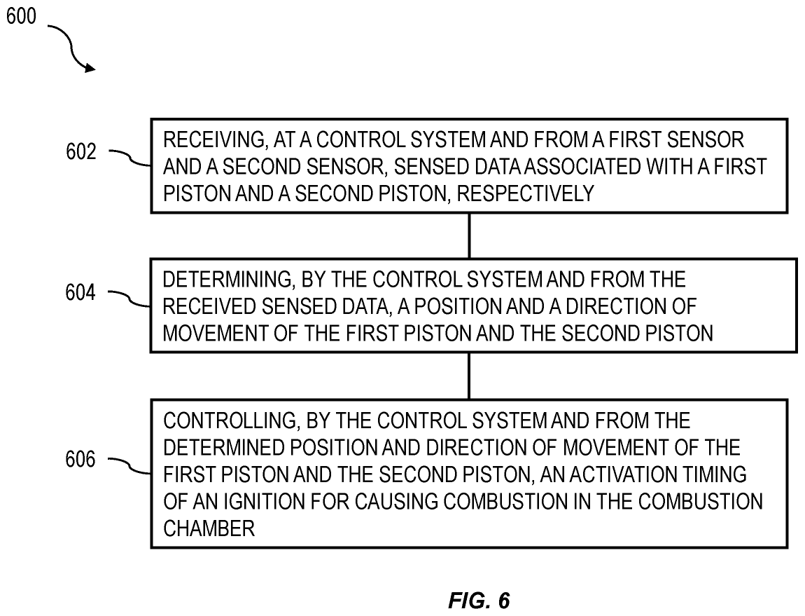

FIG. 6 shows another process flow diagram illustrating aspects of a method having one or more features consistent with implementations of the current subject matter. It will be understood that other implementations may include or exclude certain features. At 602, the control system 250 of the hybrid opposed piston engine 200 can receive sensed data from a first sensor 240 associated with the first piston 220 and/or first crankshaft assembly 230 and a second sensor 240 associated with the second piston 222 and/or second crankshaft assembly 232. At 604, the control system 250 can determine, from the received sensed data, a position and a direction of movement of the first piston 220 and the second piston 222. At 606, the control system 250 can control, as a result of the determined position and direction of movement of the first piston 220 and the second piston 222, an activation timing of an ignition of the hybrid opposed piston engine 200 for causing combustion in the combustion chamber 242. For example, the control system 250 can control a timing of a delivery of a spark from the ignition to cause the combustion, and such timing can coincide with a desired volume in the combustion chamber 242, as well as a direction of travel of the first and second pistons 220, 222.

Other features and functions associated with the hybrid opposed piston engine are within the scope of this disclosure.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

Terminology

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the teachings herein. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A hybrid opposed piston engine, comprising:
a cylindrical chamber;
first and second pistons slidably disposed in the cylindrical chamber, surfaces of the first and second pistons and walls of the cylindrical chamber defining an internal combustion volume;
at least one port in the cylindrical chamber to allow air and fuel into and exhaust gas out of the internal combustion volume;
a first electrical component controlling a first crankshaft coupled to the first piston, the first electrical component controlling the first crankshaft to control a position of the first piston within the cylindrical chamber;
a second electrical component controlling a second crankshaft coupled to the second piston, the second electrical component controlling the second crankshaft to control a position of the second piston within the cylindrical chamber;
a control system including a volume scheduling control feature for dynamically controlling a position of the first and second pistons for achieving a net desired internal combustion volume during a combustion cycle.

2. The hybrid opposed piston engine of claim 1, wherein the dynamic controlling of the position of the first and second pistons is based on a comparison of the net desired internal combustion volume during the combustion cycle and an expected internal combustion volume during the combustion cycle.

3. The hybrid opposed piston engine of claim 1, further comprising one or more sensors associated with the first crankshaft and the second crankshaft for sensing position data, the control system using the sensed position data to assist with determining the expected internal combustion volume.

4. The hybrid opposed piston engine of claim 1, wherein the control system changes an output to the first and/or second electrical components for achieving the desired internal combustion volume.

5. The hybrid opposed piston engine of claim 1, wherein the control system includes an ignition control feature for controlling a timing of ignition activation.

6. The hybrid opposed piston engine of claim 5, wherein the timing of ignition activation is based on a predetermined internal combustion chamber volume in the internal combustion chamber.

7. The hybrid opposed piston engine of claim 6, further comprising one or more sensors configured to sense position data associated with the first crankshaft and the second crankshaft, the control system using the sensed position data to assist with determining the presence of the predetermined internal combustion volume in the combustion chamber.

8. The hybrid opposed piston engine of claim 1, wherein the electrical component includes one or more of an electric motor, a generator, a servo motor, an induction motor and a piezoelectric motor.

9. A method of a hybrid opposed piston engine, comprising:
receiving, at a control system of the hybrid opposed piston engine, sensed data associated with a first piston and a second piston;
determining, by the control system and as a result of the received sensed data, a difference between an expected combustion volume during a combustion cycle and a measured combustion volume during the combustion cycle; and
controlling, by the control system and as a result of the determined difference, a movement of the first piston and the second piston to achieve the desired combustion volume during the combustion cycle in real-time.

10. The method of claim 9, wherein the sensed data is provided by a first sensor associated with the first piston and a second sensor associated with the second piston.

11. The method of claim 10, wherein the first sensor and the second sensor include an angle encoder.

12. The method of claim 9, wherein the controlling a movement of the first piston and the second piston is implemented via current control by at least one electrical component to control the first piston and the second piston.

13. The method of claim 12, wherein the at least one electrical component comprises one or more of an electric motor, a generator, a servo motor, an induction motor and a piezoelectric motor.

14. The method of claim 9, further comprising:
controlling, by the control system, a timing of ignition activation to achieve the desired combustion volume during the combustion cycle in real-time.

15. The method of claim 9, further comprising:
controlling, by the control system, a phasing of the combustion cycle to achieve the desired combustion volume during the combustion cycle in real-time.

16. A method of a hybrid opposed piston engine, comprising:
receiving, at a control system of the hybrid opposed piston engine, sensed data associated with a first piston and a second piston;
determining, by the control system and as a result of the received sensed data, a position and a direction of movement of the first piston and the second piston; and
controlling, by the control system and as a result of the determined position and direction of movement of the first piston and the second piston, an activation timing of an ignition for causing combustion in the combustion chamber.

17. The method of claim 16, wherein the sensed data is provided by a first sensor associated with the first piston and a second sensor associated with the second piston.

18. The method of claim 17, wherein the first sensor and the second sensor include an angle encoder.

19. The method of claim 16, wherein the controlling an activation timing of an ignition is implemented via current control by at least one electrical component to control the first piston and the second piston.

20. The method of claim 19, wherein the at least one electrical component comprises one or more of an electric motor, a generator, a servo motor, an induction motor and a piezoelectric motor.
